(19) United States
(12) Patent Application Publication
(10) Pub. No.: US 2026/0320438 A1
(43) Pub. Date: Oct. 15, 2026

(54) ARTIFICIAL INTELLIGENCE COMMUNICATION METHOD AND APPARATUS, AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 19/484,255

(22) PCT Filed: May 15, 2023
(86) PCT No.: PCT/CN2023/094229

§ 371 Date: Nov. 13, 2025

(51) Int. Cl. G06N 5/04

(52) U.S. Cl. CPC G06N 5/04

(57) ABSTRACT

The present disclosure relates to an Artificial Intelligence (AI) communication method and device. The Artificial Intelligence (AI) communication method includes: determining the processing time, the processing time being the time for processing an AI function or an AI model.

### CROSS-REFERENCE TO RELATED APPLICATION(S)

The present application is a U.S. National Stage of International Application No. PCT/CN2023/094229 filed on May 15, 2023, the disclosure of which is incorporated herepin by reference in its entirety.

### TECHNICAL FIELD

The present disclosure relates to the field of communication technology, and in particular to an Artificial Intelligence (AI) communication method, apparatus, and storage medium.

### BACKGROUND

In recent years, Artificial Intelligence (AI) technology has made continuous breakthroughs in many fields. Among related technologies, the introduction of AI technology into wireless air interfaces has helped to improve wireless transmission technology. Currently, it is possible to apply AI technology into wireless air interfaces for the purpose of processing, including training and inference of AI models.

### SUMMARY

According to a first aspect of embodiments of the present disclosure, an AI communication method is provided, performed by a terminal, and including: determining a processing time, where the processing time is the time for processing an AI function or an AI model.

According to a second aspect of embodiments of the present disclosure, an AI communication method is provided, performed by a network device, and including: receiving first information, where the first information is used to determine a processing time, and the processing time is the time for processing an AI function or an AI model.

According to a third aspect of embodiments of the present disclosure, an AI communication device is provided, including: a processor; and a memory for storing processor-executable instructions. The processor is configured to perform the first aspect and any one of the methods in the first aspect.

According to a fourth aspect of embodiments of the present disclosure, an AI communication device is provided, including: a processor; and a memory for storing processor-executable instructions. The processor is configured to perform the second aspect and any one of the methods in the second aspect.

It should be understood that the above general description and the following detailed description are examples and explanatory only, and do not limit the present disclosure.

### BRIEF DESCRIPTION OF THE DRAWINGS

The accompanying drawings, which are incorporated in and form part of the present specification, illustrate embodiments consistent with the present disclosure and, together with the description, serve to explain the principles of the present disclosure.

FIG. 1 is a schematic diagram of a wireless communication system illustrated according to an example embodiment.

FIG. 2 is a flowchart of an AI communication method illustrated according to an example embodiment.

FIG. 3 is a flowchart of another AI communication method illustrated according to an example embodiment.

FIG. 4 is a flowchart of another AI communication method illustrated according to an example embodiment.

FIG. 5 is a flowchart of another AI communication method illustrated according to an example embodiment.

FIG. 6 is a flowchart of another AI communication method illustrated according to an example embodiment.

FIG. 7 is a flowchart of another AI communication method illustrated according to an example embodiment.

FIG. 8 is a flowchart of another AI communication method illustrated according to an example embodiment.

FIG. 9 is a flowchart of another AI communication method illustrated according to an example embodiment.

FIG. 10 is a flowchart of another AI communication method illustrated according to an example embodiment.

FIG. 11 is a flowchart of another AI communication method illustrated according to an example embodiment.

FIG. 12 is a flowchart of another AI communication method illustrated according to an example embodiment.

FIG. 13 is a flowchart of another AI communication method illustrated according to an example embodiment.

FIG. 14 is a flowchart of another AI communication method illustrated according to an example embodiment.

FIG. 15 is a flowchart of another AI communication method illustrated according to an example embodiment.

FIG. 16 is a flowchart of another AI communication method illustrated according to an example embodiment.

FIG. 17 is a flowchart of another AI communication method illustrated according to an example embodiment.

FIG. 18 is a flowchart of another AI communication method illustrated according to an example embodiment.

FIG. 19 is a flowchart of another AI communication method illustrated according to an example embodiment.

FIG. 20 is a flowchart of another AI communication method illustrated according to an example embodiment.

FIG. 21 is a flowchart of another AI communication method illustrated according to an example embodiment.

FIG. 22 is a flowchart of another AI communication method illustrated according to an example embodiment.

FIG. 23 is a flowchart of another AI communication method illustrated according to an example embodiment.

FIG. 24 is a flowchart of another AI communication method illustrated according to an example embodiment.

FIG. 25 is a flowchart of another AI communication method illustrated according to an example embodiment.

FIG. 26 is a flowchart of another AI communication method illustrated according to an example embodiment.

FIG. 27 is a flowchart of another AI communication method illustrated according to an example embodiment.

FIG. 28 is a flowchart of another AI communication method illustrated according to an example embodiment.

FIG. 29 is a flowchart of another AI communication method illustrated according to an example embodiment.

FIG. 30 is a flowchart of another AI communication method illustrated according to an example embodiment.

FIG. 31 is a schematic diagram about method interactions of an AI communication system illustrated according to an example embodiment.

FIG. 32 is a block diagram of an AI communication apparatus illustrated according to an example embodiment.

FIG. 33 is a block diagram of another AI communication apparatus illustrated according to an example embodiment.

FIG. 34 is a block diagram of another AI communication apparatus illustrated according to an example embodiment.

FIG. 35 is a block diagram of another AI communication apparatus illustrated according to an example embodiment.

### DETAILED DESCRIPTION OF THE EMBODIMENTS

Example embodiments will now be described in detail, examples of which are illustrated in the accompanying drawings. When the following description relates to the drawings, unless otherwise indicated, the same numbers in different drawings represent the same or similar elements. The embodiments described in the following example embodiments do not represent all the embodiments consistent with the present disclosure.

The communication method involved in the present disclosure may be applied to the wireless communication system 100 shown in FIG. 1. The network system may include a network device 110 and a terminal 120. It is understood that the wireless communication system shown in FIG. 1 is merely illustrative, and the wireless communication system may also include other network devices, such as core network device(s), wireless relay device(s), and wireless backhaul device(s), etc., not shown in FIG. 1. The embodiments of the present disclosure do not limit the number of network devices and terminals included in the wireless communication system.

Furthermore, it is understood that the wireless communication system in the embodiments of the present disclosure is a network providing wireless communication functionality. The wireless communication system may employ different communication technologies, such as Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier Frequency Division Multiple Access (Single Carrier FDMA or SC-FDMA), or Carrier Sense Multiple Access with Collision Avoidance. Based on factors such as capacity, speed, and latency of different networks, networks may be categorized as 2G, 3G, 4G, or future evolution networks, such as the 5th Generation Wireless Communication System (5G) network, which may also be referred to as New Radio (NR). For the ease of description, the present disclosure sometimes refers to wireless communication networks simply as “networks”.

Furthermore, the network device 110 involved in the present disclosure may also be referred to as a wireless access network device. The wireless access network device may be: a base station, an evolved Node B (eNB), a home base station, an Access Point (AP) in a Wireless Fidelity (WIFI) system, a wireless relay node, a wireless backhaul node, a Transmission Point (TP), or a Transmission and Receiving Point (TRP), etc. It may also be a gNB in an NR system, or a component or part of a base station. When it is a vehicle-to-everything (V2X) communication system, the network device may also be an in-vehicle device. It should be understood that the specific technology and specific device form used in the embodiments of the present disclosure are not limited.

Furthermore, the terminal 120 involved in the present disclosure may also be called a terminal device, User Equipment (UE), Mobile Station (MS), Mobile Terminal (MT), etc., and is a device that provides voice and/or data connectivity to a user. For example, the terminal may be a handheld device with wireless connection functionality, an in-vehicle device, etc. Currently, examples of terminals include: smartphones (mobile phones), pocket personal computers (PPCs), handheld computers, personal digital assistants (PDAs), laptops, tablets, wearable devices, and in-vehicle devices. Furthermore, when it is in a vehicle-to-everything (V2X) communication system, the terminal device may also be an in-vehicle device. It should be understood that the present disclosure does not limit the specific technology or device form used by the terminal.

In the embodiments of the present disclosure, the network device 110 and the terminal 120 may use any feasible wireless communication technology to mutual data transmission. The transmission channel corresponding to transmission of data or control information by the network device 110 to the terminal 120 is called the downlink channel (DL), and the transmission channel corresponding to transmission of data or control information by the terminal 120 to the network device 110 is called the uplink channel (UL). It is understood that the network device involved in the embodiments of the present disclosure may be a base station. It shall be noted that the network device may also be any other possible network device, and the terminal may be any possible terminal. The present disclosure is not limited in this regard.

The widespread application of 5G technology has brought tremendous changes to all aspects of people's lives. According to the ITU's vision, 5G will permeate all aspects of future society, building a comprehensive information ecosystem centered on the user. Specifically, 5G user experience speeds may reach 100 Mbit/s to 1 Gbit/s, supporting ultimate service experiences such as mobile virtual reality; 5G peak speeds may reach 10 Gbit/s to 20 Gbit/s, with a traffic density of 10 Mbit/s/m², supporting more than a thousandfold increase in future mobile service traffic; 5G connection density may reach 1 million/m², effectively supporting massive numbers of IoT devices; 5G transmission latency may be down to the millisecond level, meeting the stringent requirements of vehicle-to-everything (V2X) and industrial control; 5G may support mobile speeds of 500 km/h, providing a good user experience even in high-speed rail environments. It is conceivable that 5G, as a representative of new infrastructure, will reshape the future information society.

In recent years, Artificial Intelligence (AI) technology has made continuous breakthroughs in many fields. Among related technologies, the introduction of AI technology into the wireless air interface helps to improve wireless transmission technology. Currently, AI technology may be applied into wireless air interfaces for the purpose of processing, including training and inference of an AI model.

In wireless AI research, AI feature use-cases refer to communication scenarios where a specific communication operation is performed based on AI to achieve a certain purpose. For example, AI feature use-cases include:
AI-based Channel State Information (CSI) enhancement;
AI-based beam management;
AI-based localization.

In some scenarios, multiple AI functions are defined for a single AI feature use-case. For example, for beam enhancement, AI function 1 supports predicting the identity (ID) of the optimal beam, while AI function 2 supports predicting the optimal beam and the corresponding beam measurement result. The implementation of AI functions relies on AI models. Different AI functions may be implemented using different AI models. Furthermore, the number of AI models corresponding to a given AI function may also vary. This results in different processing time for processing AI functions or AI models. For example, the processing time for activating or switching AI functions or AI models also differs.

In other scenarios, when an AI model is deployed on a terminal, the terminal registers the AI model with the network device and obtains the ID of the AI model. However, the obtained ID of the AI model is only for the logical AI model. A single logical AI model may exist in different physical AI models. That is, the number of physical AI models corresponding to a single AI model ID varies. This results in different processing time for AI functions or models, such as different processing time required to activate or switch AI functions or models.

However, in related technologies, the processing time for an AI function or model is not clearly defined. Clearly defining the processing time for the AI function or model is crucial for AI communication based on the AI function or model. For example, activating or switching an AI function or model requires starting the corresponding hardware and software device. The network device and the terminal need the clearly-defined processing time and, after the processing time, invoke the AI model deployed on the other end to implement the corresponding AI function.

Therefore, the present disclosure provides an Artificial Intelligence communication method. By specifying the processing time for an AI function or an AI model, the processing time for the AI function or the AI model is determined, thereby reducing the complexity in subsequent processing based on the AI function or the AI model. For example, it can be ensured that the terminal and the network device are time-aligned based on the processing time, enabling synchronous processing of the AI model or the AI function, thus improving the operation efficiency of the AI function or the AI model.

The processing on the AI function or the AI model involved in the embodiments of the present disclosure, or the “processing” involved in processing the AI function or the AI model, may be one or more of activation, switching, configuration, inference, etc.

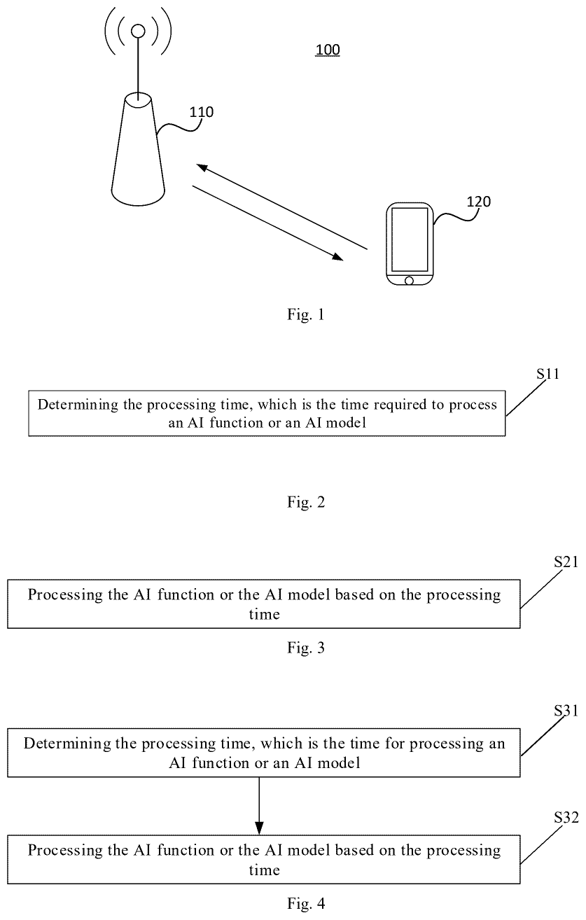

FIG. 2 is a flowchart of an AI communication method illustrated according to an example embodiment. As shown in FIG. 2, the AI communication method is performed by a terminal, and the method may include the following step(s).

In step S11, the processing time is determined, which is the time required to process an AI function or an AI model.

In an embodiment, the terminal may determine the processing time for processing an AI function or an AI model.

For example, it may be the processing time for an AI function. Different AI functions may correspond to different AI models, and the number of AI models corresponding to different AI functions may also be different. Thus, the processing time for different AI functions will also be different. In some cases, the more AI models corresponding to an AI function, the longer the processing time for that AI function may be. In other cases, the AI model corresponding to an AI function is complex, and the processing time may be longer compared to an AI function with correspondingly a less complex AI model. The processing time for AI functions may vary in different situations, and the present disclosure does not limit this. In an embodiment, the terminal may determine the processing time for different AI functions.

Another example is the processing time for an AI model. Since the number of physical AI models corresponding to different AI model IDs is different, in some cases, the more physical AI models corresponding to an AI model ID, the longer the processing time for the AI model may be. The processing time for different AI models may be different. In an embodiment, the terminal may determine the processing time for different AI models.

For example, the same AI function or AI model may have different processing time due to different environments, such as deployment on different terminals. In an embodiment, the terminal may determine the processing time for the same AI function or AI model.

The present disclosure determines the time for processing an AI function or an AI model by determining the processing time, thereby reducing the complexity in subsequent processing based on the AI function or the AI model and improving the operation efficiency of the AI function or the AI model.

In an embodiment, the AI communication method provided by the present disclosure may process the AI function or the AI model based on the processing time.

FIG. 3 is a flowchart of an AI communication method illustrated according to an example embodiment. As shown in FIG. 3, the AI communication method is performed by a terminal, and the method may include the following step(s).

In step S21, the AI function or the AI model is processed based on the processing time.

The processing time is the time for processing the AI function or the AI model. In an embodiment, the terminal may process the AI function or the AI model based on the determined processing time. Within the processing time, the terminal may perform corresponding processing on the AI function or the AI model. After the processing time, the terminal may be considered to have completed the corresponding processing on the AI function or the AI model.

For example, the activation time for activating a certain AI function is considered. The terminal may determine the activation time for activating the AI function. When the user invokes the AI function, the terminal activates the AI function based on the determined activation time. After the activation time has elapsed, the AI function may be considered to be fully activated, and the user may use the AI function.

FIG. 4 is a flowchart of an AI communication method illustrated according to an example embodiment. As shown in FIG. 4, the AI communication method is performed by the terminal, and the method may include the following step(s).

In step S31, a processing time is determined, which is the time for processing an AI function or an AI model.

In step S32, the AI function or the AI model is processed based on the processing time.

In an embodiment, the terminal may determine the processing time and then perform corresponding processing on the AI function or the AI model based on the processing time. The present disclosure determines the processing time for different AI functions or AI models, and processes the AI functions or AI models based on the processing time. This determination of the processing time for the AI functions or the AI models reduces the complexity in subsequent processing based on the AI functions or the AI models, thereby improving the operation efficiency of the AI functions or the AI models.

In some embodiments, the processing time for different AI functions or different AI models is the same in the AI communication method provided by the present disclosure.

In an embodiment, the terminal may determine that the processing time for different AI functions or different AI models is the same. That is, the processing time for different AI functions or different AI models is determined to be the same. Compared to determining the processing time for each different AI function or AI model, the embodiment can improve efficiency.

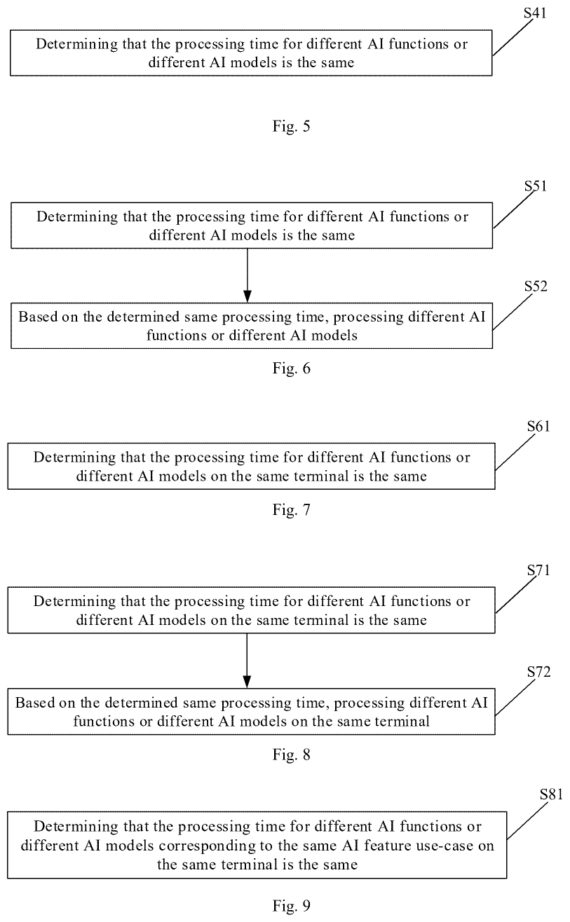

In an embodiment, FIG. 5 is a flowchart of an AI communication method illustrated according to an example embodiment. As shown in FIG. 5, the AI communication method is performed by the terminal, and the method may include the following step(s).

In step S41, it is determined that the processing time for different AI functions or different AI models is the same.

In some cases, taking AI functions as an example, the terminal may determine the processing time for different AI functions based on the AI function with the highest complexity among the different AI functions. Because more complex AI functions tend to have longer processing time, the processing time determined based on the most complex AI function may often be applied to other AI functions with relatively lower complexity among the different AI models mentioned above.

It shall be understood that determining the processing time based on the most complex AI function among different AI functions ensures that the respective processing on that most complex AI function is completed within the processing time, while also ensures, as far as possible, that the respective processing on other relatively less complex AI functions is completed within the processing time.

Furthermore, it shall be understood that using AI functions as an example again, the terminal may also determine the processing time for different AI functions based on those AI functions that are relatively complex, but not the most complex. Determining the processing time for different AI functions based on those AI functions that are relatively complex among the different AI functions ensures, as far as possible, that most of the AI functions among the different AI functions above may be processed accordingly within the processing time. At the same time, since the complexity is not the highest, the processing time will not be too long, improving efficiency. For example, when processing a less complex AI function among different AI functions, the respective processing may only require a very short time. However, since the processing time is determined based on the most complex AI function, an excessively long processing time means that even after the corresponding processing on an AI function is completed, other processing cannot proceed until the processing time is reached, wasting time and reducing efficiency.

In other cases, again using AI functions as an example, the terminal may determine the processing time for different AI functions based on the AI function used most frequently among different AI functions.

It is understood that the embodiment is explained using AI functions, but the implementation methods involved also apply to AI models, and the present disclosure is not limited thereto.

In some embodiments, the terminal may process different AI functions or AI models based on the determined same processing time.

In some embodiments, FIG. 6 is a flowchart of an AI communication method illustrated according to an example embodiment. As shown in FIG. 6, the AI communication method is performed by the terminal, and the method may include the following step(s).

In step S51, it is determined that the processing time for different AI functions or different AI models is the same.

In step S52, based on the determined same processing time, different AI functions or different AI models are processed.

The processing time includes, for example, the activation time for the AI function or the AI model, the switching time for the AI function or the AI model, and the time for switching from a non-AI state to an AI state. The processing time for different AI functions or different AI models may be defined separately.

The execution process of step S51 in this embodiment is similar to that of step S41, and will not be repeated here.

The present disclosure improves efficiency by determining that the processing time for different AI functions or AI models is the same. Processing different AI functions or AI models based on the determined processing time reduces the processing complexity, thereby improving the operation efficiency of the AI functions or the AI models.

In some embodiments, in the AI communication method provided by the present disclosure, the processing time for different AI functions or different AI models on the same terminal is the same.

In an implementation, the terminal may determine that the processing time for different AI functions or different AI models on the same terminal is the same. It may be assumed that since the terminal is the same, the software and hardware environments for different AI functions or AI models are the same. Therefore, the terminal determines that the processing time for different AI functions or different AI models on the same terminal is the same.

In an implementation, FIG. 7 is a flowchart of an AI communication method illustrated according to an example embodiment. As shown in FIG. 7, the AI communication method is performed by the terminal, and the method may include the following step(s).

In step S61, it is determined that the processing time for different AI functions or different AI models on the same terminal is the same.

For example, different terminals have different computing power, storage space, etc. Processing AI functions or AI models requires the support of the terminal's computing power and storage space. Here, computing power may be understood as the terminal's processing capability. It may be assumed that the higher the terminal's computing power and the larger the terminal's storage space, the less processing time is required when processing AI functions or AI models. That is, the terminal's computing power and storage space affect the time it takes to process AI functions or AI models. The computing power and storage space of the same terminal keeps the same. Therefore, the terminal may determine that different AI functions or different AI models on the same terminal have the same processing time, which helps to improve efficiency.

In some embodiments, the terminal may process different AI functions or different AI models of the same terminal based on the determined same processing time.

In some embodiments, FIG. 8 is a flowchart of an AI communication method illustrated according to an example embodiment. As shown in FIG. 8, the AI communication method is performed by the terminal, and the method may include the following step(s).

In step S71, it is determined that the processing time for different AI functions or different AI models on the same terminal is the same.

In step S72, based on the determined same processing time, different AI functions or different AI models on the same terminal are processed.

The execution process of steps S71 and S61 in this embodiment is similar and will not be described again here.

The present disclosure improves efficiency by determining that the processing time for different AI functions or AI models on the same terminal is the same. Processing different AI functions or AI models based on the determined processing time reduces the complexity of the processing process, thereby improving the operation efficiency of the AI functions or the AI models.

In some embodiments, in the AI communication method provided by the present disclosure, the processing time for different AI functions or different AI models corresponding to the same AI feature use-case on the same terminal is the same.

In an embodiment, the terminal may determine that the processing time for different AI functions or different AI models corresponding to the same AI feature use-case on the same terminal is the same. Here, the AI feature use-case is a communication scenario based on a communication operation to reach its corresponding purpose. For example, using AI to predict channel information in the time domain. Another example is using AI for spatial beam management. The AI feature use-case includes at least one AI function or AI model. The AI function(s) or AI model(s) corresponding to the same AI feature use-case is similar. Specifically, taking AI-based beam management as an example, AI-based beam management includes multiple AI functions. For example, AI function 1 may be measuring the optimal beam ID, and AI function 2 may be predicting the optimal beam and the measurement result of the corresponding beam. It may be considered that the above-mentioned AI function 1 and AI function 2 are similar. Since there may be similarities between the AI function(s) or AI model(s) of the same AI feature use-case, the terminal may determine that the processing time for different AI functions or AI models of the same AI feature use-case on the same terminal is the same.

In an embodiment, FIG. 9 is a flowchart of an AI communication method illustrated according to an example embodiment. As shown in FIG. 9, the AI communication method is performed by a terminal, and the method may include the following step(s).

In step S81, it is determined that the processing time for different AI functions or different AI models corresponding to the same AI feature use-case on the same terminal is the same.

In an embodiment, the terminal may determine the AI feature use-case on the same terminal, and for the AI feature use-case, determine that the processing time for different AI functions or different AI models corresponding to the AI feature use-case is the same.

In some embodiments, the terminal may process different AI functions or different AI models corresponding to the same AI feature use-case on the same terminal based on the determined same processing time.

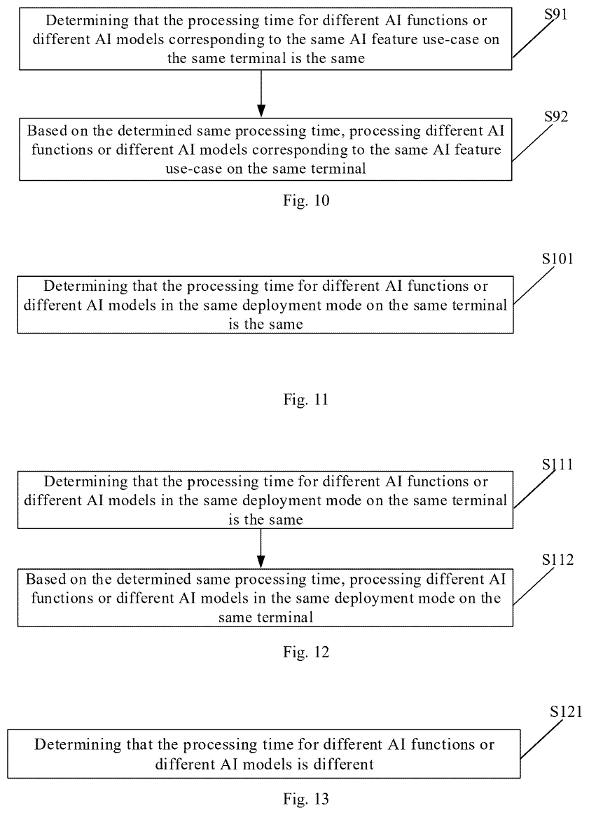

In some embodiments, FIG. 10 is a flowchart of an AI communication method illustrated according to an example embodiment. As shown in FIG. 10, the AI communication method is performed by a terminal, and the method may include the following step(s).

In step S91, it is determined that the processing time for different AI functions or different AI models corresponding to the same AI feature use-case on the same terminal is the same.

In step S92, based on the determined same processing time, different AI functions or different AI models corresponding to the same AI feature use-case on the same terminal are processed.

The execution processes of steps S91 and S81 in this embodiment are similar and will not be repeated here.

The present disclosure is more targeted and the determined processing time is more accurate by determining that the processing time for different AI functions or different AI models corresponding to the same AI feature use-case on the same terminal is the same. Processing different AI functions or AI models corresponding to the same AI feature use-case on the same terminal based on the determined processing time reduces the complexity of the processing process and improves the operation efficiency of the AI functions or the AI models.

In some embodiments, in the Artificial Intelligence communication method provided by the present disclosure, the processing time for different AI functions or different AI models in the same deployment mode on the same terminal is the same.

In an embodiment, the terminal may determine that the processing time for different AI functions or different AI models in the same deployment mode on the same terminal is the same.

The deployment mode for AI functions or AI models includes one-sided deployment and two-sided deployment. Taking AI models as an example, a one-sided deployment model refers to deployment on one device. For example, the AI model is deployed on a terminal or network device. A two-sided deployment model indicates that a part of the AI model is deployed on the terminal and another part is deployed on a network device. For example, AI functions or AI models corresponding to AI feature use-cases such as AI-based localization and AI-based beam management typically employ the one-sided deployment mode. AI-based CSI compression typically employs the two-sided deployment mode.

It is understood that the deployment mode for the AI feature use-cases mentioned above are merely examples, and the present disclosure does not limit the specific deployment mode used for each AI feature use-case.

In an embodiment, different deployment modes affect the time required to process AI functions or AI models. Often, AI functions or AI models with the same deployment mode require relatively similar processing time. Therefore, the terminal may determine that the processing time for different AI functions or different AI models with the same deployment mode on the same terminal is the same.

In an embodiment, FIG. 11 is a flowchart of an AI communication method illustrated according to an example embodiment. As shown in FIG. 11, the AI communication method is performed by the terminal, and the method may include the following step(s).

In step S101, it is determined that the processing time for different AI functions or different AI models in the same deployment mode on the same terminal is the same.

In an embodiment, the terminal may determine the deployment mode on the same terminal, which may include the one-sided deployment or the two-sided deployment. This identifies AI functions or models in the same deployment mode. For AI functions or models in the same deployment mode, their processing time is determined to be the same.

For example, for an AI function or model in the one-sided deployment mode on the same terminal, the processing time thereof is determined to be Time 1. For an AI function or model in the two-sided deployment mode on the same terminal, the processing time thereof is determined to be Time 2. It shall be noted that for the AI function or model in the two-sided deployment mode on the same terminal, the processing time there of may also be determined to be Time 1. The present disclosure is not limited thereto.

As another example, for the same terminal, if the AI function or model is deployed on the terminal, the processing time thereof is determined to be Time 3. For the same terminal, if the AI function or model is deployed on the network device, the processing time thereof is determined to be Time 4. It shall be noted that for the AI function or model deployed on the network device, the processing time thereof may also be determined to be Time 3. The present disclosure is not limited thereto.

It is understood that Time 1, Time 2, Time 3, and Time 4 in this embodiment are example descriptions and do not represent specific time. The present disclosure is specifically limited thereto.

In some embodiments, the terminal may process different AI functions or different AI models in the same deployment mode on the same terminal based on the determined same processing time.

In some embodiments, FIG. 12 is a flowchart of an AI communication method illustrated according to an example embodiment. As shown in FIG. 12, the AI communication method is performed by a terminal, and the method may include the following step(s).

In step S111, it is determined that the processing time for different AI functions or different AI models in the same deployment mode on the same terminal is the same.

In step S112, based on the determined same processing time, different AI functions or different AI models in the same deployment mode on the same terminal are processed.

The execution process of steps S111 and S101 in this embodiment is similar and will not be described again here.

The present disclosure, by determining that the processing time for different AI functions or different AI models corresponding to the same deployment mode on the same terminal is the same, is more targeted, and the determined processing time is more accurate. Processing different AI functions or AI models corresponding to the same deployment mode on the same terminal based on the determined processing time reduces the complexity of the processing process, thereby improving the operation efficiency of the AI functions or the AI models.

In some embodiments, the processing time for different AI functions or different AI models varies in the AI communication method provided by the present disclosure.

In an embodiment, the terminal may also determine that the processing time for different AI functions or different AI models is different. That is, the processing time is determined for each AI function or AI model. In an embodiment, the processing time for an AI function or an AI model may be determined specifically.

In an embodiment, FIG. 13 is a flowchart of an AI communication method illustrated according to an example embodiment. As shown in FIG. 13, the AI communication method is performed by the terminal, and the method may include the following step(s).

In step S121, it is determined that the processing time for different AI functions or different AI models is different.

In an embodiment, the terminal may determine the processing time for different AI functions or AI models separately. Taking an AI function as an example, the terminal may determine the processing time for each different AI function based on the complexity of the AI function, the deployment mode of the AI function, the number of AI models corresponding to the AI function, etc. Alternatively, taking an AI model as an example, the terminal may also determine the processing time for each different AI model based on the complexity of the AI model, the deployment mode of the AI model, the number of physical AI models corresponding to the AI model ID, etc.

In some implementations, the terminal may process different AI functions or different AI models based on the determined different processing time.

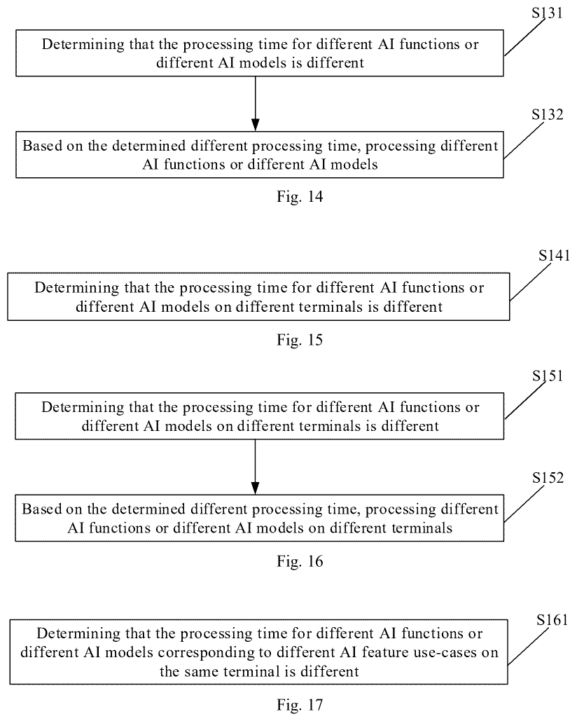

In some implementations, FIG. 14 is a flowchart of an AI communication method illustrated according to an example embodiment. As shown in FIG. 14, the AI communication method is performed by the terminal and may include the following step(s).

In step S131, it is determined that the processing time for different AI functions or different AI models is different.

In step S132, based on the determined different processing time, different AI functions or different AI models are processed.

The execution processes of steps S131 and S121 in this embodiment are similar and will not be repeated here.

The present disclosure, by determining that the processing time for different AI functions or different AI models is different, enables more targeted determination of the processing time for different AI functions or different AI models, resulting in more accurate processing time. Processing different AI functions or AI models based on the determined processing time reduces the complexity of the processing process, thereby improving the operation efficiency of the AI functions or the AI models.

In some embodiments, in the Artificial Intelligence communication method provided by the present disclosure, the processing time for different AI functions or different AI models on different terminals is different.

In an embodiment, for different AI functions or different AI models on different terminals, since the corresponding terminals are different, their software and hardware environments may also be considered different. The terminal may determine that the processing time for different AI functions or different AI models on different terminals is different. That is, the processing time is determined separately for different AI functions or different AI models on different terminals.

In an embodiment, FIG. 15 is a flowchart of an AI communication method illustrated according to an example embodiment. As shown in FIG. 15, the AI communication method is performed by a terminal, and the method may include the following step(s).

In step S141, it is determined that the processing time for different AI functions or different AI models on different terminals is different.

In an embodiment, since different terminals have different computing power, storage space, etc., the terminal may determine the processing time for different AI functions or different AI models on different terminals respectively.

In some embodiments, the terminal may process different AI functions or different AI models on different terminals based on the determined different processing time.

In some embodiments, FIG. 16 is a flowchart of an AI communication method illustrated according to an example embodiment. As shown in FIG. 16, the AI communication method is performed by a terminal, and the method may include the following step(s).

In step S151, it is determined that the processing time for different AI functions or different AI models on different terminals is different.

In step S152, based on the determined different processing time, different AI functions or different AI models on different terminals are processed.

The execution process of steps S151 and S141 in this embodiment is similar and will not be described again here.

The present disclosure determines the processing time specifically for different AI functions or different AI models on different terminals, by identifying different processing time for the different AI functions or the different AI models, thus enabling more accurate processing time. Processing different AI functions or models on different terminals based on the determined processing time reduces the complexity of the processing process and improves the operation efficiency of the AI functions or models.

In some embodiments, the AI communication method provided by the present disclosure has different processing time for different AI functions or models corresponding to different AI feature use-cases on the same terminal.

In an embodiment, for the same terminal, there are significant differences in the AI functions or models corresponding to different AI feature use-cases. Therefore, the terminal may determine that the processing time for different AI functions or models corresponding to the AI feature use-cases on the same terminal is different.

In an embodiment, FIG. 17 is a flowchart of an AI communication method illustrated according to an example embodiment. As shown in FIG. 17, the AI communication method is performed by the terminal and may include the following step(s).

In step S161, it is determined that the processing time for different AI functions or models corresponding to different AI feature use-cases on the same terminal is different.

In an embodiment, the terminal determines the AI function or AI model corresponding to each AI feature use-case among different AI feature use-cases on the same terminal. The processing time for different AI functions or different AI models corresponding to different AI use-cases is determined separately.

In some embodiments, the terminal may process different AI functions or different AI models corresponding to different AI feature use-cases on the same terminal based on the determined different processing time.

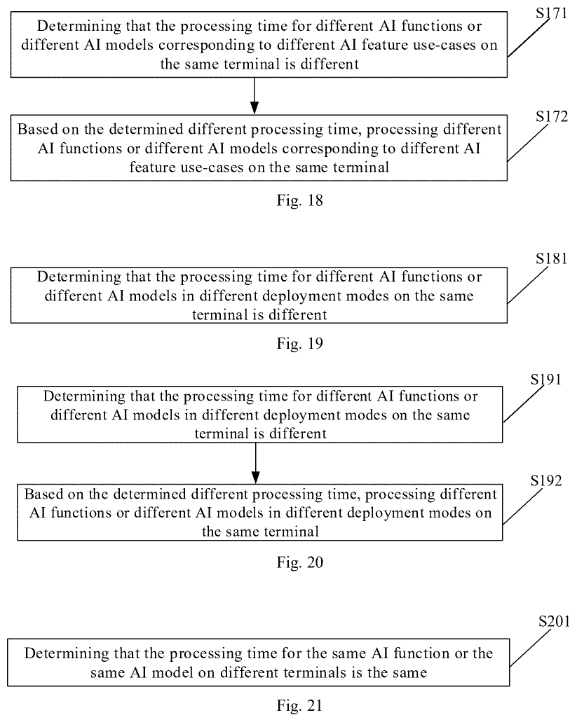

In some embodiments, FIG. 18 is a flowchart of an AI communication method illustrated according to an example embodiment. As shown in FIG. 18, the AI communication method is performed by the terminal, and the method may include the following step(s).

In step S171, it is determined that the processing time for different AI functions or different AI models corresponding to different AI feature use-cases on the same terminal is different.

In step S172, based on the determined different processing time, different AI functions or different AI models corresponding to different AI feature use-cases on the same terminal are processed.

The execution process of steps S171 and S161 in this embodiment is similar and will not be repeated here.

The present disclosure, by determining that the processing time for different AI functions or different AI models corresponding to different AI feature use-cases on the same terminal is different, is more targeted, and the determined processing time is more accurate. By processing different AI functions or AI models corresponding to different AI feature use-cases on the same terminal based on the determined processing time, the complexity of the processing process is reduced, thereby improving the operation efficiency of the AI functions or the AI models.

According to some embodiments, in the AI communication method provided by the present disclosure, the processing time for different AI functions or different AI models in different deployment modes on the same terminal is different.

In an embodiment, since different deployment modes affect the time required to process AI functions or AI models, the terminal may determine that the processing time for different AI functions or different AI models in different deployment modes on the same terminal is different. That is, the processing time for AI functions or AI models in different deployment modes on the same terminal may be determined separately.

For example, taking AI functions as an example, for different AI functions in the one-sided deployment, the processing time thereof is determined as Time 1. For different AI functions in the two-sided deployment, the processing time thereof is determined as Time 2. Time 1 and Time 2 are different. That is, determining that the processing time is different for AI functions in different deployment modes allows for a more targeted and accurate determination of the processing time for each AI function.

In an embodiment, FIG. 19 is a flowchart of an AI communication method illustrated according to an example embodiment. As shown in FIG. 19, the AI communication method is performed by a terminal, and the method may include the following step(s).

In step S181, it is determined that the processing time for different AI functions or different AI models in different deployment modes on the same terminal is different.

In an embodiment, the terminal may determine the deployment modes for different AI functions or AI models based on the fact that the terminal for different AI functions or AI models is the same. For each deployment mode, the processing time for the corresponding different AI functions or AI models is determined separately.

In some implementations, the terminal may process different AI functions or different AI models in different deployment modes on the same terminal based on the determined different processing time.

FIG. 20 is a flowchart of an AI communication method illustrated according to an example embodiment. As shown in FIG. 20, the AI communication method is performed by the terminal and may include the following step(s).

In step S191, it is determined that the processing time for different AI functions or different AI models in different deployment modes on the same terminal is different.

In step S192, based on the determined different processing time, different AI functions or different AI models in different deployment modes on the same terminal are processed. The execution processes of steps S191 and S181 in this embodiment are similar and will not be repeated here.

The present disclosure, by determining that the processing time for different AI functions or different AI models corresponding to different deployment modes on the same terminal is different, is more targeted and the determined processing time is more accurate. Processing different AI functions or AI models corresponding to different deployment modes on the same terminal based on the determined processing time reduces the complexity of the processing process, thereby improving the operation efficiency of the AI functions or the AI models.

In some embodiments, according to the AI communication method proposed by the present disclosure, the processing time for the same AI function or the same AI model on different terminals is the same; or, the processing time for the same AI function or the same AI model on different terminals is different.

In an embodiment, in some cases, the processing time for the same AI function or the same AI model on different terminals may be determined to be the same. That is, regardless of which terminal corresponds to the AI function or the AI model, the same processing time may be determined. This saves time in determining the same AI function or the same AI model on different terminals, improving efficiency. In other cases, the processing time for the same AI function or the same AI model on different terminals may also be determined to be different. Since different terminals have different computing power, storage space, etc., even for the same AI function or AI model, the processing time required for different terminals to process will also differ. Therefore, the processing time for the same AI function or AI model on different terminals may be determined separately. The targeted determination of the processing time for the same AI function or AI model on each terminal results in the more accurate processing time.

In some embodiments, FIG. 21 is a flowchart of an AI communication method illustrated according to an example embodiment. As shown in FIG. 21, the AI communication method is performed by a terminal, and the method may include the following step(s).

In step S201, it is determined that the processing time for the same AI function or the same AI model on different terminals is the same.

In an embodiment, the terminal determines the processing time for a certain AI function or AI model. Furthermore, it is determined that the processing time for this AI function or AI model on different terminals is the same.

In some embodiments, the terminal may process the same AI function or the same AI model on different terminals based on the determined same processing time.

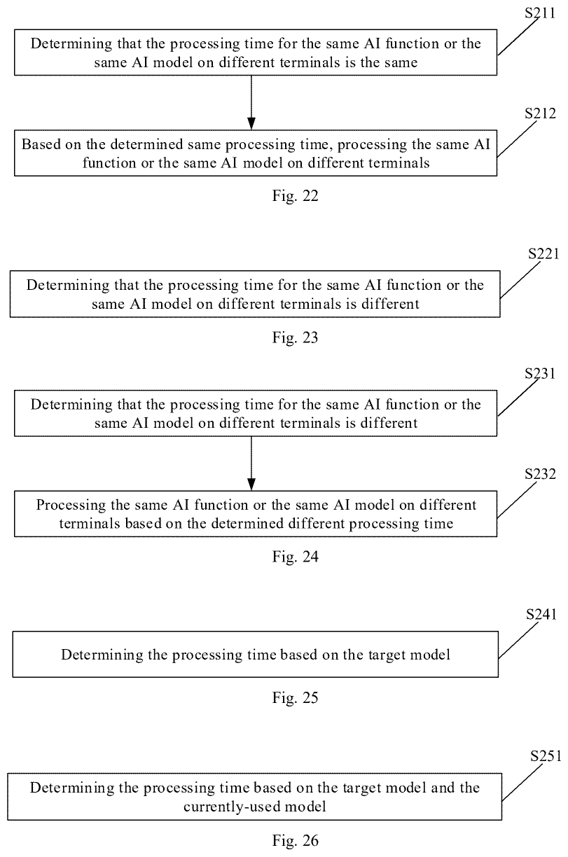

In an embodiment, FIG. 22 is a flowchart of an AI communication method illustrated according to an example embodiment. As shown in FIG. 22, the AI communication method is performed by a terminal, and the method may include the following step(s).

In step S211, it is determined that the processing time for the same AI function or the same AI model on different terminals is the same.

In step S212, based on the determined same processing time, the same AI function or the same AI model on different terminals is processed.

The execution process of steps S211 and S201 in this embodiment is similar and will not be described again here.

In some embodiments, FIG. 23 is a flowchart of an AI communication method illustrated according to an example embodiment. As shown in FIG. 23, the AI communication method is performed by a terminal, and the method may include the following step(s).

In step S221, it is determined that the processing time for the same AI function or the same AI model on different terminals is different.

In an embodiment, the terminal may determine different terminals corresponding to the same AI function or AI model. For each terminal, the processing time for the same AI function or AI model is determined. For example, the processing time for the same AI function or AI model may be determined based on the computing power of different terminals. Alternatively, the terminal may also determine the processing time for the same AI function or AI model for example based on the storage space of different terminals. The above-mentioned determination of the processing time for the same AI function or AI model based on the computing power and/or storage space of different terminals is merely an example, and the present disclosure is not limited thereto.

In some embodiments, FIG. 24 is a flowchart of an AI communication method illustrated according to an example embodiment. As shown in FIG. 24, the AI communication method is performed by a terminal, and the method may include the following step(s).

In step S231, it is determined that the processing time for the same AI function or the same AI model on different terminals is different.

In step S232, the same AI function or the same AI model on different terminals is processed based on the determined different processing time.

The execution process of steps S231 and S221 in this embodiment is similar and will not be repeated here.

The present disclosure improves efficiency by determining whether the processing time for the same AI function or the same AI model on different terminals is the same or different. Alternatively, it may more accurately and specifically determine the processing time for the same AI function or AI model on each terminal. Processing the same AI function or the same AI model on different terminals based on the determined processing time reduces the complexity of the processing process, thereby improving the operation efficiency of the AI function or the AI model.

In some embodiments, according to the AI communication method provided by the present disclosure, processing an AI function or an AI model includes at least one of the following: activation of an AI function or an AI model, switching of an AI function or an AI model, configuration of an AI function or an AI model, or inference of an AI function or an AI model.

Activation of an AI function or an AI model may be understood as starting a certain AI function or AI model. Switching of an AI function or an AI model may be understood as switching the current AI function or AI model to a target AI function or AI model, or activating an AI function or a target AI model, causing the terminal to switch from a non-AI state to an AI state. Configuration of an AI function or an AI model may be understood as configuring the environment for the AI function or the AI model. Inference of an AI function or an AI model may be understood as the process for predicting or inferring about the AI function or the AI model using data.

In an embodiment, the terminal may determine the processing time for any of the above-described processing processes on the AI function or the AI model.

The present disclosure, by determining the processing time, achieves the determination of the time for processing the AI function or the AI model, thereby reducing the complexity in subsequent processing based on the AI function or the AI model and improving the operation efficiency of the AI function or the AI model.

In some embodiments, according to the Artificial Intelligence communication method provided by the present disclosure, the processing includes at least one of the following: activation of an AI function or an AI model, or switching of an AI function or an AI model. The processing time is determined based on the target model, or the processing time is determined based on the target model and the currently-used model.

In an implementation, the activation time and the switching time of the AI function or the AI model may be determined based on the target model. The target model is the activated AI model or the switched AI model.

FIG. 25 is a flowchart of an AI communication method illustrated according to an example embodiment. As shown in FIG. 25, the AI communication method is performed by a terminal, and the method may include the following step(s).

In step S241, the processing time is determined based on the target model.

For example, the terminal activates the target model, and the activation time is determined based on the target model. In some cases, the activation time of the target model may be determined based on factors such as the complexity of the target model. The target model is the activated AI model. In other cases, the terminal activates the target model, switching from a non-AI state to an AI state. The time for the terminal to switch from a non-AI state to an AI state may also be determined based on the target model. Specifically, the time for the terminal to switch from a non-AI state to an AI state may be determined based on the activation time of the target model.

As another example, when switching from the currently-used AI model to the target model, the switching time may be determined based on the target model. The target model is the switched AI model. In some cases, the time to switch from the currently-used AI model to the target model may be determined based on factors such as the complexity of the target model. In other cases, switching from the currently-used AI model to the target model requires activating the target model. The terminal may determine the time to switch from the currently-used AI model to the target model based on the activation time of the target model.

In an implementation, the activation time of an AI function or an AI model and the switching time of an AI function or an AI model may be determined based on the target model and the currently-used model. The target model is the activated AI model or the switched AI model.

FIG. 26 is a flowchart of an AI communication method illustrated according to an example embodiment. As shown in FIG. 26, the AI communication method is performed by a terminal, and the method may include the following step(s).

In step S251, the processing time is determined based on the target model and the currently-used model.

For example, the switching time from the currently-used AI model to the target model may be determined based on the currently-used model and the target model. In some cases, the terminal may determine the time to switch from the currently-used AI model to the target model based on factors such as the complexity of the currently-used model and the target model. Specifically, the time to switch from the currently-used AI model to the target model may be determined based on the model with higher complexity between the currently-used model and the target model. In other cases, the terminal may determine the time to switch from the currently-used AI model to the target model based on the time when the currently-used model was shut down and the time when the target model was activated. Specifically, the time to switch from the currently-used AI model to the target model may be determined based on the larger value between the time when the currently-used model was shut down and the time when the target model was activated.

It is understood that the above-mentioned description about determining the activation time of the target model based on the complexity of the target model and so on are merely examples. The present disclosure does not limit how the terminal specifically determines the activation time of an AI model, the switching time of an AI model, etc., based on the target model.

The present disclosure achieves determination of the processing time for an AI functions or an AI model by determining the processing time based on a target model, or by determining the time for the AI function or the AI model based on the currently-used model and the target model. This reduces the complexity in subsequent processing based on the AI function or the AI model, thereby improving the operation efficiency of the AI function or the AI model.

In some embodiments, according to the AI communication method provided by the present disclosure, a first part of the AI function or the AI model is deployed on a terminal, and a second part of the AI function or the AI model is deployed on a network device. The processing time is determined based on the processing time for the first part of the AI function or the AI model. And/or, the processing time is determined based on the processing time for the second part of the AI function or the AI model.

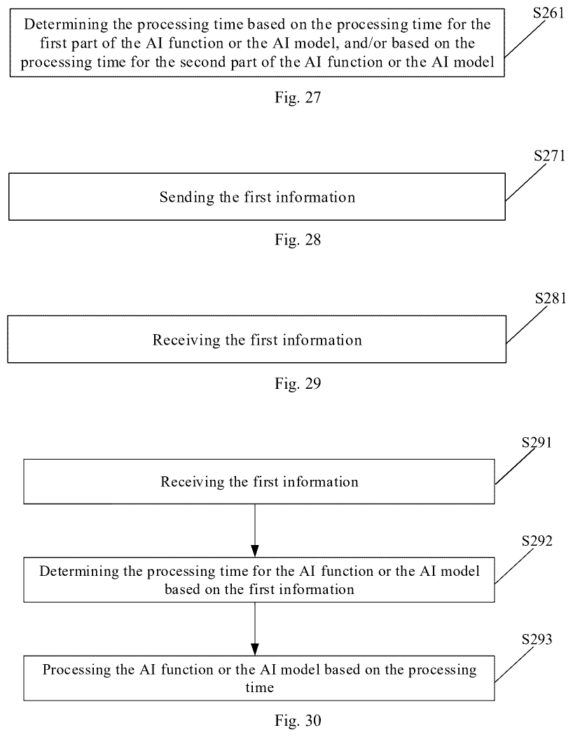

FIG. 27 is a flowchart of an AI communication method illustrated according to an example embodiment. As shown in FIG. 27, the AI communication method is performed by a terminal, and the method may include the following step(s).

In step S261, the processing time is determined based on the processing time for the first part of the AI function or the AI model, and/or, the processing time is determined based on the processing time for the second part of the AI function or the AI model.

In an implementation, if the AI function or the AI model is deployed in the two-sided deployment mode, the processing time for the AI function or the AI model may be determined based on the first part of the AI function or the AI model deployed on the terminal.

For example, if the activation time of the first part of the AI function or the AI model is Time 1, then the activation time of the AI function or the AI model may be determined based on the activation time of the first part of the AI function or the AI model, i.e., it is determined to be Time 1.

In an implementation, the terminal may also determine the processing time for the AI function or AI model based on the second part of the AI function or the AI model deployed on the network device.

For example, if the activation time of the second part of the AI function or the AI model is Time 2, then the activation time of the AI function or the AI model may be determined based on the activation time of the second part of the AI function or the AI model, i.e., it is determined to be Time 2.

In an implementation, the terminal may also determine the processing time for the AI function or the AI model based on both the first and second parts of the AI function or the AI model.

For example, the terminal may determine the processing time based on the larger value between Time 1 and Time 2.

The present disclosure determines the processing time based on the processing time for the first part of the AI function or the AI model, and/or based on the processing time for the second part of the AI function or the AI model, enabling flexible determination of the processing time for the AI function or the AI model.

In some embodiments, FIG. 28 is a flowchart of an AI communication method illustrated according to an example embodiment. As shown in FIG. 28, the AI communication method is performed by a terminal, and the method may include the following step(s).

In step S271, first information is sent, which is used by the network device to determine the processing time.

In an embodiment, the terminal may send the first information to the network device, the first information including the processing time, so that the network device can determine the processing time and ensure time alignment between the terminal and the network device.

In an embodiment, taking the activation of a certain AI function as an example, the terminal determines the time to activate the AI function and sends the first information containing the time to the network device, so that the network device can determine the time to activate the AI function. The terminal and the network device may simultaneously determine that the AI function has been activated after the time passes, thereby allowing further processing on the AI function.

The present disclosure, by sending the first information, ensures that the terminal and the network device are time-aligned based on the processing time, enabling synchronous processing on the AI model or the AI functions to improve the operation efficiency of the AI function or the AI model.

In some embodiments, according to the AI communication method provided by the present disclosure, the processing time corresponds to different AI models or AI functions.

In an embodiment, the first information sent by the terminal includes the processing time, which corresponds to different AI functions or AI models. That is, different AI functions or AI models have the same processing time. Therefore, the processing time in the first information may be used by the network device to determine the processing time for different AI functions or AI models.

The present disclosure, by sending the first information, ensures that the terminal and the network device are time-aligned based on the processing time, enabling synchronous processing on the AI model or the AI function to improve the operation efficiency of the AI function or the AI model.

In some embodiments, according to the AI communication method provided by the present disclosure, the first information includes information indicating the AI function or the AI model, and the processing time corresponding to the AI function or the AI model.

In an embodiment, the first information includes the processing time corresponding to different AI functions or AI models respectively. That is, different AI functions or AI models have different processing time. Therefore, this allows the network device to determine the processing time corresponding to different AI functions or AI models based on the information in the first information indicating the AI function or the AI model, and the processing time corresponding to the AI function or the AI model.

By sending the first information, the present disclosure ensures that the terminal and the network device are time-aligned based on the processing time, enabling synchronous processing on the AI model or the AI function to improve the operation efficiency of the AI function or the AI model.

Based on the same concept, the present disclosure also provides an AI communication method performed by a network device.

FIG. 29 is a flowchart of an AI communication method illustrated according to an example embodiment. As shown in FIG. 29, the method includes the following step(s).

In step S281, the first information is received.

In an embodiment, the network device receives the first information sent by the terminal. The first information includes the processing time for the AI function or the AI model, and is used by the network device to determine the processing time for the AI function or the AI model. That is, the network device may determine the processing time for the AI function or the AI model based on the first information.

In some embodiments, FIG. 30 is a flowchart of an AI communication method illustrated according to an example embodiment. As shown in FIG. 30, the AI communication method is performed by the terminal, and the method may include the following step(s).

In step S291, the first information is received.

In step S292, the processing time for the AI function or the AI model is determined based on the first information.

In an embodiment, the network device may determine the processing time for the same AI function or AI model as the terminal based on the processing time for the AI function or the AI model included in the first information.

In step S293, the AI function or the AI model is processed based on the processing time.

In an embodiment, the network device may process the AI function or the AI model based on the processing time. For example, the network device may activate the AI function or the AI model.

The present disclosure allows the network device to determine the processing time by receiving the first information. The first information is used by the network device to determine the processing time for the AI function or the AI model. This ensures that the terminal and the network device process the AI model or the AI function synchronously, thereby improving the operation efficiency of the AI function or the AI model.

In some embodiments, the processing time for different AI functions or different AI models is the same in the AI communication method provided by the present disclosure.

In an embodiment, the processing time for different AI functions or different AI models is the same. Compared to the different processing time for each different AI function or AI model, this implementation improves efficiency.

The present disclosure determines that the processing time for different AI functions or AI models is the same through the network device, which improves efficiency and enables synchronous processing of the AI model or the AI function by the terminal and the network device, thereby improving the operation efficiency of the AI function or the AI model.

In some implementations, according to the AI communication method provided by the present disclosure, the processing time for different AI functions or different AI models on the same terminal is the same.

In an implementation, since the terminal is the same, the software and hardware environments of different AI functions or AI models are the same. Therefore, the processing time for different AI functions or different AI models on the same terminal may be the same.

For example, different terminals have different computing power, storage space, etc. Processing AI functions or AI models requires the support of the terminal's computing power and storage space. Here, the computing power may be understood as the terminal's processing capability. It may be considered that the higher the terminal's computing power and the larger the storage space, the less processing time is required when processing AI functions or AI models. That is to say, the terminal's computing power and storage space affect the time it takes to process AI functions or AI models. The computing power and the storage space of the same terminal keep the same. Therefore, the processing time for different AI functions or different AI models on the same terminal is the same.

The present disclosure improves efficiency by determining that the processing time for different AI functions or different AI models on the same terminal is the same through the network device. This enables synchronous processing of AI models or AI functions by the terminal and the network device, thereby improving the operation efficiency of AI functions or AI models.

In some embodiments, the Artificial Intelligence communication method provided by the present disclosure determines that the processing time for different AI functions or different AI models corresponding to the same AI feature use-case on the same terminal is the same.

In an embodiment, the network device determines that the processing time for different AI functions or different AI models corresponding to the same AI feature use-case on the same terminal is the same based on the first information. Since there may be similarities between AI functions or AI models of the same AI feature use-case, the processing time for different AI functions or AI models of the same AI feature use-case on the same terminal is the same.

The present disclosure, by determining that the processing time for different AI functions or different AI models corresponding to the same AI feature use-case on the same terminal is the same through the network device, is more targeted, and the determined processing time is more accurate. This enables synchronous processing of AI models or AI functions by the terminal and the network device, thereby improving the operation efficiency of AI functions or models.

In some embodiments, the AI communication method provided by the present disclosure allows different AI functions or different AI models in the same deployment mode on the same terminal to have the same processing time.

In an embodiment, the network device determines, based on the first information, that different AI functions or different AI models in the same deployment mode on the same terminal have the same processing time.

The deployment mode of the AI function or the AI model includes the one-sided deployment and the two-sided deployment. Different deployment modes affect the time required to process AI functions or AI models. Often, AI functions or AI models in the same deployment mode have relatively similar processing time. Therefore, different AI functions or different AI models in the same deployment mode on the same terminal have the same processing time.

For example, for an AI function or an AI model in the one-sided deployment mode on the same terminal, the processing time is Time 1. For an AI function or an AI model in the two-sided deployment mode on the same terminal, the processing time is Time 2. It shall be noted that the processing time for the AI function or the AI model in the two-sided deployment mode on the same terminal as described above may also be Time 1, and the present disclosure is not limited thereto.

For example, for the same terminal, if the AI function or the AI model is deployed on the terminal, the processing time thereof is Time 3. For the same terminal, if the AI function or the AI model is deployed on the network device, the processing time thereof is Time 4. It shall be noted that for the same terminal as described above, the processing time for the AI function or the AI model deployed on the network device may also be Time 3, and the present disclosure is not limited thereto.

It is understood that Time 1, Time 2, Time 3, and Time 4 in this embodiment are illustrative descriptions and do not represent specific time. The present disclosure does not specifically limit them.

The present disclosure determines that the processing time for different AI functions or different AI models corresponding to the same deployment mode on the same terminal is the same through the network device, which is more targeted and the determined processing time is more accurate. This enables the terminal and the network device to process the AI model or the AI function synchronously, thereby improving the operation efficiency of the AI function or the AI model.

In some embodiments, according to the Artificial Intelligence communication method provided by the present disclosure, the processing time differs for different AI functions or different AI models.

In an embodiment, the network device determines that the processing time differs for different AI functions or different AI models based on the first information. That is, the processing time is determined for each AI function or AI model. In an embodiment, the processing time for AI functions or AI models may be determined specifically.

In an embodiment, the terminal may determine the processing time for different AI functions or AI models respectively. Taking AI functions as an example, the terminal may determine the processing time for each different AI function based on its complexity, deployment mode, and the number of AI models corresponding thereto. Alternatively, taking AI models as an example, the terminal may also determine the processing time for each different AI model based on its complexity, deployment mode, and the number of physical AI models corresponding to its ID.

The present disclosure determines that the processing time for different AI functions or different AI models is different through the network device, enabling a more targeted and accurate determination of the processing time for different AI functions or different AI models. This allows the terminal and the network device to process AI models or AI functions synchronously, thereby improving the operation efficiency of AI functions or AI models.

In some embodiments, the processing time for different AI functions or different AI models on different terminals is different according to the Artificial Intelligence communication method provided by the present disclosure.

In an embodiment, for different AI functions or different AI models on different terminals, since the corresponding terminals are different, their software and hardware environments may also be considered different. Based on the first information, the network device may determine that the processing time for different AI functions or different AI models on different terminals is different. That is, the processing time is determined separately for different AI functions or different AI models on different terminals.

In an embodiment, since different terminals have different computing power, storage space, etc., the processing time may be determined separately for different AI functions or different AI models on different terminals.

The present disclosure determines that the processing time for different AI functions or different AI models on different terminals is different through the network device, allowing for a targeted determination of the processing time for different AI functions or different AI models, and the more accurate processing time. This enables synchronous processing of AI models or AI functions by the terminal and the network device, thereby improving the operation efficiency of AI functions or AI models.

In some embodiments, in the Artificial Intelligence communication method provided by the present disclosure, the processing time for different AI functions or different AI models corresponding to different AI feature use-cases on the same terminal is different.

In an embodiment, for the same terminal, there are significant differences in the AI functions or AI models corresponding to different AI feature use-cases. Therefore, based on the first information, the network device may determine that the processing time for different AI functions or different AI models corresponding to the AI feature use-case(s) on the same terminal is different.

The present disclosure determines, through the network device, that the processing time for different AI functions or different AI models corresponding to different AI feature use-cases on the same terminal is different, making the determined processing time to be more targeted and accurate. This enables synchronous processing of AI models or AI functions by the terminal and the network device, thereby improving the operation efficiency of AI functions or models.

In some embodiments, according to the AI communication method provided by the present disclosure, the processing time for different AI functions or different AI models in different deployment modes on the same terminal is different.

In an embodiment, because different deployment modes affect the time required to process AI functions or models, the network device may determine, based on the first information, that the processing time for different AI functions or different AI models in different deployment modes on the same terminal is different. That is, the processing time for AI functions or AI models in different deployment modes on the same terminal may be determined separately.

For example, taking AI functions as an example, for different AI functions in the one-sided deployment, their processing time is determined as Time 1; for different AI functions in the two-sided deployment, their processing time is determined as Time 2, where Time 1 and Time 2 are different. In other words, by determining that the processing time for AI functions in different deployment modes is different, the present disclosure allows for a more targeted and accurate determination of the processing time for each AI function.

The present disclosure, by determining that the processing time for different AI functions or different AI models corresponding to different deployment modes on the same terminal is different, is more targeted and the determined processing time is more accurate. Processing different AI functions or AI models corresponding to different deployment modes on the same terminal based on the determined processing time enables synchronous processing of AI models or AI functions by the terminal and the network device, thereby improving the operation efficiency of AI functions or AI models.

In some embodiments, according to the Artificial Intelligence communication method provided by the present disclosure, the processing time for the same AI function or the same AI model on different terminals is the same; or, the processing time for the same AI function or the same AI model on different terminals is different.

In an embodiment, in some cases, for the same AI function or the same AI model on different terminals, the network device may determine that their processing time is the same based on the first information. That is, regardless of which terminal corresponds to the AI function or the AI model, the same processing time may be determined. This saves time in determining the same AI function or the same AI model on different terminals and improves efficiency. In other cases, for the same AI function or the same AI model on different terminals, the network device may determine that the processing time thereof is different based on the first information. Since different terminals have different computing power, storage space, etc., the processing time required by the different terminals to process the same AI function or AI model will vary. Therefore, the processing time for the same AI function or AI model on different terminals may be determined by the terminal separately. The targeted determination of the processing time for the same AI function or AI model on each terminal results in the more accurate processing time.

The present disclosure, by determining whether the processing time for the same AI function or the same AI model on different terminals is the same or different, can improve efficiency; or, by targeting the determination of the processing time for the same AI function or AI model on each terminal, allows the more accurate processing time. Based on the determined processing time, processing the same AI function or the same AI model on different terminals enables synchronous processing of the AI model or the AI function by the terminal and the network device, thereby improving the operation efficiency of the AI function or the AI model.

In some embodiments, according to the AI communication method provided by the present disclosure, processing an AI function or an AI model includes at least one of the following: activation of an AI function or an AI model, switching of an AI function or an AI model, configuration of an AI function or an AI model, and inference of an AI function or an AI model.

Activation of an AI function or an AI model may be understood as starting a specific AI function or AI model. Switching of an AI function or an AI model may be understood as switching the current AI function or AI model to a target AI function or AI model, or activating an AI function or a target AI model, causing the terminal to switch from a non-AI state to an AI state. Configuration of an AI function or an AI model may be understood as configuring the environment of the AI function or the AI model. Inference of an AI function or an AI model may be understood as the process for predicting or inferring about the AI function or the AI model using data.

In an embodiment, the network device may determine the processing time for performing any of the above-described processing processes on the AI function or the AI model based on the first information.

The present disclosure determines the processing time through the network device, thereby ensuring time alignment between the terminal and the network device based on the processing time. This enables synchronous processing of AI models or AI functions, improving the operation efficiency of AI functions or AI models.

In some embodiments, according to the AI communication method provided by the present disclosure, the processing includes at least one of the following: activation of an AI function or an AI model, and switching of an AI function or an AI model. The processing time is determined based on the target model, or the processing time is determined based on the target model and the currently-used model.

In an embodiment, the activation time and the switching time of the AI function or the AI model may be determined based on the target model. The target model is the activated AI model or the switched AI model.

For example, the activation time is determined according to the target model. In some cases, the activation time of the target model may be determined based on factors such as the complexity of the target model. The target model is the activated AI model. In other cases, the target model is activated, switching from a non-AI state to an AI state. The time for switching from a non-AI state to an AI state may also be determined based on the target model. Specifically, the time for the terminal to switch from a non-AI state to an AI state may be determined based on the activation time of the target model.

For example, when switching from the currently-used AI model to the target model, the switching time may be determined based on the target model. The target model is the switched AI model. In some cases, the switching time from the currently-used AI model to the target model may be determined based on factors such as the complexity of the target model. In other cases, switching from the currently-used AI model to the target model requires activating the target model. The switching time from the currently-used AI model to the target model is determined based on the activation time of the target model.

In an implementation, the activation time and the switching time of the AI function or the AI model may be determined based on the target model and the currently-used model. The target model is either the activated AI model or the switched AI model.

For example, when switching from the currently-used AI model to the target model, the switching time may be determined based on the currently-used model and the target model. In some cases, the switching time from the currently-used AI model to the target model is determined based on factors such as the complexity of the currently-used model and the target model. Specifically, the switching time from the currently-used AI model to the target model may be determined based on the model with higher complexity between the currently-used model and the target model. In other cases, the switching time from the currently-used AI model to the target model is determined based on the time when the currently-used model is shut down and the time when the target model is activated. Specifically, the switching time from the currently-used AI model to the target model may be determined based on the larger one between the time when the currently-used model is shut down and the time when the target model is activated.

It is understood that the above-mentioned determination of the activation time of the target model based on the complexity of the target model and so on is merely an example. The present disclosure does not limit how the activation time of the AI model or the switching time of the AI model is specifically determined based on the target model.

The present disclosure, by determining the processing time based on the target model, or by determining the time for the AI function or the AI model based on the currently-used model and the target model, can ensure that the terminal and the network device are time-aligned based on the processing time, enabling synchronous processing of the AI model or the AI function, thereby improving the operation efficiency of the AI function or the AI model.

In some embodiments, according to the Artificial Intelligence communication method provided by the present disclosure, the first part of the AI function or the AI model is deployed on the terminal, and the second part of the AI function or the AI model is deployed on the network device. The processing time is determined based on the processing time for the first part of the AI function or the AI model. And/or, the processing time is determined based on the processing time for the second part of the AI function or the AI model.

In an implementation, if the AI function or the AI model is in the two-sided deployment mode, the processing time for the AI function or the AI model may be determined based on the first part of the AI function or the AI model deployed on the terminal.

For example, if the activation time of the first part of the AI function or the AI model is Time 1, then the activation time of the AI function or the AI model may be determined based on the activation time of the first part of the AI function or the AI model, i.e., determined to be Time 1.

In an implementation, the processing time for the AI function or the AI model is determined based on the second part of the AI function or the AI model deployed on the network device.

For example, if the activation time of the second part of the AI function or the AI model is Time 2, then the activation time of the AI function or the AI model may be determined based on the activation time of the second part of the AI function or the AI model, i.e., determined to be Time 2.

In an implementation, the processing time for the AI function or the AI model is determined based on the first and second parts of the AI function or the AI model.

For example, the processing time is determined based on the larger value between Time 1 and Time 2.

The present disclosure determines the processing time based on the processing time for the first part of the AI function or the AI model, and/or based on the processing time for the second part of the AI function or the AI model, enabling flexible determination of the processing time for the AI function or the AI model.

In some embodiments, according to the Artificial Intelligence communication method provided by the present disclosure, the processing time corresponds to different AI models or AI functions.

In an embodiment, the network device receives the sent first information and the first information includes the processing time, which corresponds to different AI functions or AI models. That is, different AI functions or AI models correspond to the same processing time. Therefore, the network device may determine the processing time for different AI functions or AI models based on the processing time in the first information.

The present disclosure, by receiving the first information through the network device, ensures that the terminal and the network device are time-aligned based on the processing time, enabling synchronous processing of AI models or AI functions to improve the operation efficiency of AI functions or AI models.

In some embodiments, according to the AI communication method provided by the present disclosure, the first information includes information indicating the AI function or the AI model, and the processing time corresponding to the AI function or the AI model.

In an embodiment, the first information includes the processing time corresponding to different AI functions or AI models. That is, different AI functions or AI models have different processing time. Therefore, the network device may determine the processing time corresponding to different AI functions or AI models respectively based on the information indicating the AI function or AI model in the first information, and the processing time corresponding to the AI function or AI model.

The present disclosure, by receiving the first information through the network device, ensures that the terminal and the network device are time-aligned based on the processing time, enabling synchronous processing of AI models or AI functions to improve the operation efficiency of AI functions or AI models.

It should be noted, those skilled in the art will understand that the various implementations or examples involved in the above-described embodiments of the present disclosure may be used in conjunction with the foregoing embodiments, or may be used independently. Whether used alone or in conjunction with the foregoing embodiments, the implementation principle is similar. In the present disclosure, some embodiments are described using a combined implementation. Apparently, those skilled in the art will understand that such illustrative examples are not intended to limit the embodiments of the present disclosure.

Based on the same concept, the present disclosure also provides an AI communication system.

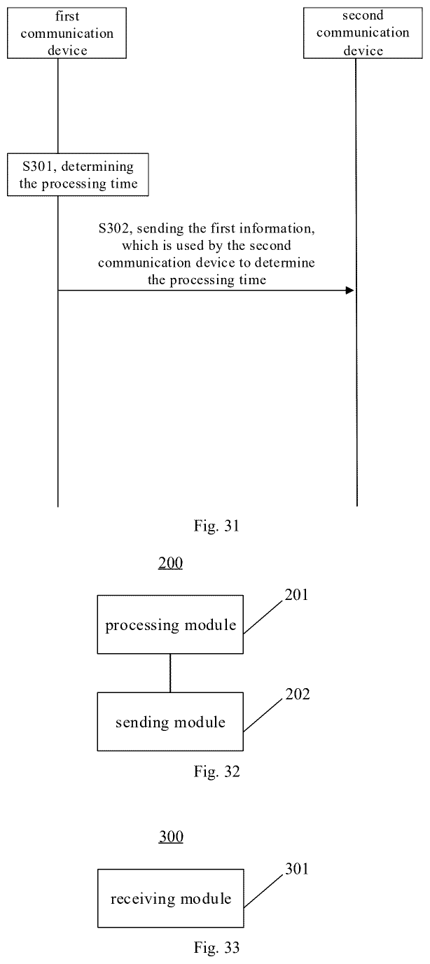

FIG. 31 is a schematic diagram about method interactions of an AI communication system illustrated according to an example embodiment. As shown in FIG. 31, the present disclosure relates to an AI communication system, and the AI communication method includes the following step(s).

In step S301, the processing time is determined.

In step S302, the first information is sent, which is used by the second communication device to determine the processing time.

In an embodiment, the first communication device determines the processing time and sends the first information to the second communication device in communication with the first communication device. The first information includes the processing time. The second communication device may determine the processing time based on the first information. Based on the processing time, the first and second communication devices may process AI functions or AI models.

According to an embodiment of the present disclosure, in the interaction scenario between the first and second communication devices, the first communication device may be a terminal or a network device, and the second communication device may be a network device or a terminal. The processing procedures on relevant information by the second communication device in the interaction scenario are the same as or similar to those by the first communication device in the interaction scenario. Therefore, for the processing procedures on relevant information by the second communication device in the interaction scenario, reference may be made to the relevant embodiments of the first communication device described above, which will not be repeated here.

Based on the same concept, the present disclosure also provides an AI communication apparatus.

It is understood that in order to achieve the above functions, the AI communication device and apparatus provided in the present disclosure include hardware structures and/or software modules executing the respective function(s) accordingly. In combination with the units and algorithm steps of the various examples disclosed in the present disclosure, the present disclosure may be implemented in hardware or a combination of hardware and computer software. Whether a function is executed by hardware or by computer software-driven hardware depends on the specific application and design constraints of the technical solution. Those skilled in the art may use different methods to implement the described functions for each specific application, but such implementation should not be considered beyond the scope of the technical solution of the present disclosure.

FIG. 32 is a schematic diagram of an AI communication apparatus illustrated according to an example embodiment. Referring to FIG. 32, the apparatus 200 is configured on a terminal. The apparatus 200 includes a processing module 201, configured to determine the processing time, which is the time required to process an AI function or an AI model.

In an embodiment, the processing time for different AI functions or different AI models is the same.

In an embodiment, the processing time for different AI functions or different AI models on the same terminal is the same.

In an embodiment, the processing time for different AI functions or different AI models corresponding to the same AI feature use-case on the same terminal is the same.

In an embodiment, the processing time for different AI functions or different AI models in the same deployment mode on the same terminal is the same.

In an embodiment, the processing time for different AI functions or different AI models is different.

In an embodiment, the processing time for different AI functions or different AI models on different terminals is different.

In an embodiment, the processing time for different AI functions or different AI models corresponding to different AI feature use-cases on the same terminal is different.

In an embodiment, the processing time for different AI functions or different AI models in different deployment modes on the same terminal is different.

In an embodiment, the processing time for the same AI function or the same AI model on different terminals is the same. Alternatively, the processing time for the same AI function or the same AI model on different terminals is different.

In an implementation, the processing includes at least one of the following: AI model activation, AI model switching, AI model configuration, or AI model inference.

In an implementation, the processing includes at least one of the following: AI model activation or AI model switching. The processing time is determined based on the target model. Alternatively, the processing time is determined based on the target model and the currently-used model. The target model is either the activated AI model or the switched AI model.

In an implementation, the first part of the AI function or the AI model is deployed on the terminal, and the second part of the AI function or the AI model is deployed on the network device. The processing time is determined based on the processing time for the first part of the AI function or the AI model. And/or, the processing time is determined based on the processing time for the second part of the AI function or the AI model.

In an implementation, the apparatus further includes: a sending module 202, configured to send first information, which is used by the network device to determine the processing time.

In an implementation, the processing time corresponds to different AI models or AI functions.

In an implementation, the first information includes information indicating an AI function or an AI model, and the processing time corresponding to the AI function or the AI model.

FIG. 33 is a schematic diagram of another AI communication apparatus illustrated according to an example embodiment. Referring to FIG. 33, the apparatus 300 is configured in a network device and includes a receiving module 301 for receiving first information. The first information is used to determine the processing time, which is the time for processing the AI function or the AI model.

In an implementation, the processing time for different AI functions or different AI models is the same.

In an implementation, the processing time for different AI functions or different AI models on the same terminal is the same.

In an implementation, the processing time for different AI functions or different AI models corresponding to the same AI feature use-case on the same terminal is the same.

In an implementation, the processing time for different AI functions or different AI models in the same deployment mode on the same terminal is the same.

In an implementation, the processing time for different AI functions or different AI models is different.

In an implementation, the processing time for different AI functions or different AI models on different terminals is different.

In an implementation, the processing time for different AI functions or different AI models corresponding to different AI feature use-cases on the same terminal is different.

In an implementation, the processing time for different AI functions or different AI models in different deployment modes on the same terminal is different.

In an implementation, the processing time is the same for the same AI function or the same AI model on different terminals; or, the processing time is different for the same AI function or the same AI model on different terminals.

In an implementation, the processing includes at least one of the following: AI model activation, AI model switching, AI model configuration, and AI model inference.

In an implementation, the processing includes at least one of the following: AI model activation, or AI model switching. The processing time is determined based on the target model. Alternatively, the processing time is determined based on the target model and the currently-used model. The target model is the activated AI model or the switched AI model.

In an implementation, the first part of the AI function or the AI model is deployed on the terminal, and the second part of the AI function or the AI model is deployed on the network device. The processing time is determined based on the processing time for the first part of the AI function or the AI model. And/or, the processing time is determined based on the processing time for the second part of the AI function or the AI model.

In an implementation, the processing time corresponds to different AI models or AI functions.

In an implementation, the first information includes information indicating the AI function or the AI model, and the processing time corresponding to the AI function or the AI model.

Regarding the apparatus in the above embodiments, the specific manner in which each module performs the respective operation has been described in detail in the embodiments related to the method, and will not be elaborated upon here.

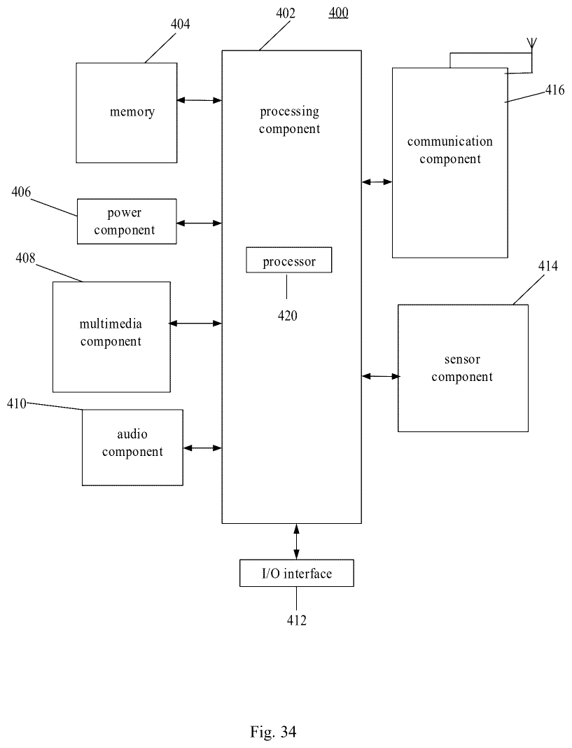

FIG. 34 is a schematic diagram of an AI communication device illustrated according to an example embodiment. For example, the device 400 may be any terminal such as a mobile phone, computer, digital broadcast terminal, messaging device, game console, tablet device, medical device, fitness device, personal digital assistant, etc.

Referring to FIG. 34, the device 400 may include one or more of the following components: processing component 402, memory 404, power component 406, multimedia component 408, audio component 410, input/output (I/O) interface 412, sensor component 414, or communication component 416.

The processing component 402 typically controls the overall operation of the device 400, such as operations associated with display, telephone calls, data communication, camera operation, and recording operation. The processing component 402 may include one or more processors 420 to execute instructions to complete all or some of the steps in the methods described above. Furthermore, the processing component 402 may include one or more modules to facilitate interactions between the processing component 402 and other components. For example, the processing component 402 may include a multimedia module to facilitate interactions between the multimedia component 408 and the processing component 402.

The memory 404 is configured to store various types of data to support operation on the device 400. Examples of such data include instructions for any application or method operating on the device 400, contact data, phonebook data, messages, pictures, videos, etc. The memory 404 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic storage, flash memory, magnetic disk, or optical disk.

The power component 406 provides power to various components of the device 400. The power component 406 may include a power management system, one or more power supplies, and other components associated with generating, managing, and distributing power to the device 400.

The multimedia component 408 includes a screen that provides an output interface between the device 400 and the user. In some embodiments, the screen may include a liquid crystal display (LCD) and a touch panel (TP). If the screen includes a touch panel, the screen may be implemented as a touchscreen to receive input signals from the user. The touch panel includes one or more touch sensors to sense touches, swipes, and gestures on the touch panel. The touch sensor may sense not only the boundary of the touch or swipe action but also the duration and pressure associated with the touch or swipe operation. In some embodiments, the multimedia component 408 includes a front-facing camera and/or a rear-facing camera. When the device 400 is in an operation mode, such as a shooting mode or a video mode, the front-facing camera and/or the rear-facing camera may receive external multimedia data. Each of the front-facing camera and the rear-facing camera may be a fixed optical lens system or have a focal length and optical zooming capability.

The audio component 410 is configured to output and/or input audio signals. For example, the audio component 410 includes a microphone (MIC) configured to receive external audio signals when the device 400 is in an operation mode, such as call mode, recording mode, or voice recognition mode. The received audio signals may be further stored in the memory 404 or transmitted via the communication component 416. In some embodiments, the audio component 410 also includes a speaker for outputting audio signals.

The I/O interface 412 provides an interface between the processing component 402 and peripheral interface modules, which may be a keyboard, click wheel, buttons, etc. These buttons may include, but are not limited to, a home button, a volume button, a power button, or a lock button.

The sensor component 414 includes one or more sensors for providing status assessments in various aspects of the device 400. For example, the sensor component 414 may detect the on/off state of the device 400, the relative positioning of components such as display and keypad of the apparatus 400, changes in position of the device 400 or a component of the device 400, the presence or absence of a user contact with the device 400, the orientation or acceleration/deceleration of the device 400, and temperature changes of the device 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an accelerometer, a gyroscope, a magnetometer, a pressure sensor, or a temperature sensor.

The communication component 416 is configured to facilitate wired or wireless communication between the device 400 and other devices. The device 400 may access wireless networks based on communication standards such as WiFi, 2G, 3G, or combinations thereof. In an example embodiment, the communication component 416 receives broadcast signals or broadcast-related information from an external broadcast management system via a broadcast channel. In another example embodiment, the communication component 416 further includes a near-field communication (NFC) module to facilitate short-range communication. For example, the NFC module may be implemented based on radio frequency identification (RFID) technology, Infrared Data Association (IrDA) technology, ultra-wideband (UWB) technology, Bluetooth (BT) technology, and other technologies.

In an example embodiment, the device 400 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components to perform the methods described above.

In an example embodiment, a non-transitory computer-readable storage medium including instructions is also provided, such as a memory 404 including instructions. The instructions may be executed by the processor 420 of the device 400 to perform the methods described above. For example, the non-transitory computer-readable storage medium may be ROM, random access memory (RAM), CD-ROM, magnetic tape, floppy disk, and optical data storage devices, etc.

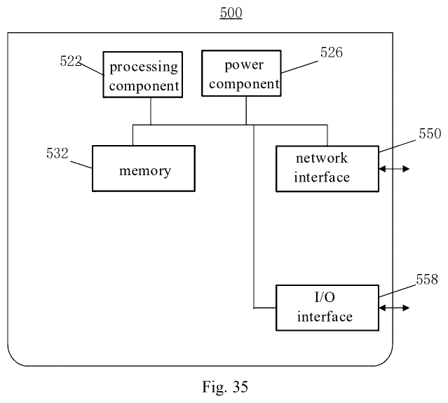

FIG. 35 is a schematic diagram of another Artificial Intelligence communication device according to an example embodiment. For example, the device 500 may be provided as a base station or a server.

Referring to FIG. 35, the device 500 includes a processing component 522, which further includes one or more processors, and memory resources represented by the memory 532 for storing instructions executable by the processing component 522, such as application programs. The application programs stored in the memory 532 may include one or more modules, each corresponding to a set of instructions. Furthermore, the processing component 522 is configured to execute instructions to perform the methods described above.

The device 500 may also include a power component 526 configured to perform power management of the device 500, a wired or wireless network interface 550 configured to connect the device 500 to a network, and an input/output (I/O) interface 558. The device 500 may operate on an operation system stored in the memory 532, such as Windows Server™, Mac OS X™, Unix™, Linux™, FreeBSD™, or similar.

In some embodiments, the present disclosure also provides a communication system including a terminal and a network device. The terminal may execute the methods described in FIGS. 2 to 5. The network device may execute the methods described in FIGS. 6 to 9. Referring specifically to the descriptions of the above embodiments, the present disclosure will not repeat them here.

The present disclosure accomplishes determination of the processing time for AI functions or AI models by clarifying and determining the processing time for AI functions or AI models, thereby reducing the complexity in subsequent processing based on AI functions or AI models. For example, this helps to ensure that the terminal and the network device are time-aligned based on the processing time, enabling synchronous processing of AI models or AI functions, and thus improving the operation efficiency of AI functions or AI models.

Furthermore, it is understood that in the present disclosure, “multiple” refers to two or more, and other quantifiers are similar. “And/or” describes the relationship between related objects, indicating that three relationships may exist. For example, A and/or B may represent: A alone, A and B simultaneously, and B alone. The character “/” generally indicates that the preceding and following related objects are in an “or” relationship. The singular forms “a,” “the,” and “said” are also intended to include the plural forms as well, unless the context clearly indicates otherwise.

It is further understood that the terms “first,” “second,” etc., are used to describe various types of information, but this information should not be limited to these terms. These terms are only used to distinguish information of the same type from one another and do not indicate a specific order or degree of importance. In fact, expressions such as “first,” “second,” etc., are completely interchangeable. For example, without departing from the scope of the present disclosure, first information may also be referred to as second information, and similarly, second information may also be referred to as first information.

It is further understood that the meaning of words such as “in response to” and “if” used in the present disclosure depends on the context and the actual usage scenario. For example, the word “in response to” as used herein may be interpreted as “when”, “while”, “if”, or “in case of”.

It is further understood that although operations are described in a specific order in the accompanying drawings according to the embodiments of the present disclosure, this should not be construed as requiring these operations to be performed in the specific order or serial order shown, or requiring all of the shown operations to obtain the desired result. In certain environments, multitasking and parallel processing may be advantageous.

Other embodiments of the present disclosure will readily occur to those skilled in the art upon consideration of the specification and practice of the content disclosed herein. The present application is intended to cover any variations, uses, or adaptations of the present disclosure that follow the general principles of the present disclosure and include common knowledge or customary techniques in the art not disclosed herein.

It should be understood that the present disclosure is not limited to the precise structures described above and shown in the accompanying drawings, and various modifications and changes may be made without departing from the scope thereof. The scope of the present disclosure is limited only by the appended claims.

1. An Artificial Intelligence (AI) communication method, performed by a terminal and comprising:
determining processing time, wherein the processing time is time for processing an AI function or an AI model.

2. The method according to claim 1, wherein the processing time is the same for different AI functions or different AI models.

3. The method according to claim 2, wherein the processing time is the same for:
different AI functions or different AI models on the same terminal; or
different AI functions or different AI models corresponding to the same AI feature use-case on the same terminal; or
different AI functions or different AI models in the same deployment mode on the same terminal.

4.-5. (canceled)

6. The method according to claim 1, wherein the processing time is different for different AI functions or different AI models.

7. The method according to claim 6, wherein the processing time is different for:
different AI functions or different AI models on different terminals; or
different AI functions or different AI models corresponding to different AI feature use-cases on the same terminal; or
different AI functions or different AI models in different deployment modes on the same terminal.

8.-9. (canceled)

10. The method according to claim 1, wherein
the processing time is the same for the same AI function or the same AI model on different terminals; or
the processing time is different for the same AI function or the same AI model on different terminals.

11. The method according to claim 1, wherein the processing comprises at least one of:
AI model activation, AI model switching, AI model configuration, or AI model inference.

12. The method according to claim 1, wherein
the processing comprises at least one of: AI model activation or AI model switching;
the processing time is determined based on a target model or determined based on the target model and a currently-used model; and
the target model is an activated AI model or a switched AI model.

13. The method according claim 1, wherein
a first part of the AI function or the AI model is deployed on the terminal, and a second part of the AI function or the AI model is deployed on a network device; and
the processing time is determined based on at least one of:
the processing time for the first part of the AI function or the AI model; or
the processing time for the second part of the AI function or the AI model.

14. The method according to claim 1, further comprising:
sending first information, wherein the first information is used by a network device to determine the processing time.

15. The method according to claim 14, wherein
the processing time corresponds to different AI models or different AI functions; or
the first information comprises information for indicating the AI function or the AI model, and the processing time corresponding to the AI function or the AI model.

16. (canceled)

17. An Artificial Intelligence (AI) communication method, performed by a network device and comprising:
receiving first information, wherein the first information is used to determine processing time, and the processing time is time for processing an AI function or an AI model.

18. The method according to claim 17, wherein the processing time is the same for different AI functions or different AI models.

19. The method according to claim 18, wherein the processing time is the same for:
different AI functions or different AI models on the same terminal; or
different AI functions or different AI models corresponding to the same AI feature use-case on the same terminal; or
different AI functions or different AI models in the same deployment mode on the same terminal.

20.-21. (canceled)

22. The method according to claim 17, wherein the processing time is different for different AI functions or different AI models.

23. The method according to claim 22, wherein the processing time is different for:
different AI functions or different AI models on different terminals; or
different AI functions or different AI models corresponding to different AI feature use-cases on the same terminal; or
different AI functions or different AI models in different deployment modes on the same terminal.

24.-25. (canceled)

26. The method according to claim 17, wherein
the processing time is the same for the same AI function or the same AI model on different terminals; or
the processing time is different for the same AI function or the same AI model on different terminals.

27. The method according to claim 17, wherein the processing comprises at least one of:
AI model activation, AI model switching, AI model configuration, or AI model inference.

28.-33. (canceled)

34. A terminal, comprising:
a processor; and
a memory for storing processor-executable instructions, wherein
the processor is configured to perform an Artificial Intelligence (AI) communication method, comprising:
determining processing time, wherein the processing time is time for processing an AI function or an AI model.

35. A network device comprising:
a processor; and
a memory for storing processor-executable instructions, wherein
the processor is configured to perform the method according to claim 17.

36.-38. (canceled)
